(19) United States
(12) Patent Application Publication
(10) Pub. No.: US 2025/0065649 A1
(43) Pub. Date: Feb. 27, 2025

(54) RECORDING APPARATUS

(71) Applicant: SEIKO EPSON CORPORATION, Tokyo (JP)

(72) Inventors: Keisuke SASAKI, MATSUMOTO-SHI (JP); Hidefumi MINEMURA, SHIOJIRI-SHI (JP)

(21) Appl. No.: 18/812,879

(22) Filed: Aug. 22, 2024

(30) Foreign Application Priority Data
Aug. 23, 2023 (JP) 2023-135599

(51) Int. Cl. B41J 13/08; B41J 13/10

(52) U.S. Cl. CPC B41J 13/08; B41J 13/106

(57) ABSTRACT

A recording apparatus includes a transport roller, a discharge roller, a medium reception tray, a motor, a power transmission unit configured to be in a power transmission state in which power of the motor is transmitted from the motor to the medium reception tray and a power non-transmission state in which the power of the motor is not transmitted from the motor to the medium reception tray, and a belt being stretched around a transport roller pulley and a discharge roller pulley. The power transmission unit is positioned between an outer end portion of the transport roller pulley and an outer end portion of the discharge roller pulley in a discharge direction.

The present application is based on, and claims priority from JP Application Serial Number 2023-135599, filed Aug. 23, 2023, the disclosure of which is hereby incorporated by reference herein in its entirety.

### BACKGROUND

### 1. Technical Field

The present disclosure relates to a recording device.

### 2. Related Art

A recording apparatus represented by a facsimile machine, a printer, and the like may include a medium reception tray that receives a medium after recording and discharging. Further, as described in JP-A-2018-16480, such a medium reception tray may be configured to be switchable between an accommodation state and an extension state by a motor.

In the recording apparatus in the related art that includes the medium reception tray configured to be switchable between the accommodation state and the extension state by the motor as described in JP-A-2018-16480, in other words, the related-art recording medium including the medium reception tray that can be displaced between a first state and a second state, a configuration of a mechanism for switching the medium reception tray between the first state and the second state may be increased in size. Further, when this mechanism is increased in size, there may be a risk that the apparatus as a whole is increased in size.

### SUMMARY

In order to solve the above-mentioned problem, a recording apparatus according to the present disclosure includes a recording head attached to a carriage and configured to perform recording on a medium, the carriage being configured to reciprocate, a transport roller configured to transport the medium, a discharge roller configured to discharge the medium on which the recording was performed, a medium reception tray configured to receive the medium being discharged by the discharge roller, the medium reception tray being configured to be in a first state and in a second state in which the medium reception tray is displaced from the first state in a discharge direction of the medium, a motor being a power source of the discharge roller, a power transmission unit configured to be in a power transmission state in which power of the motor is transmitted from the motor to the medium reception tray and a power non-transmission state in which the power of the motor is not transmitted from the motor to the medium reception tray, and a belt being stretched around a transport roller pulley provided to the transport roller and a discharge roller pulley provided to the discharge roller, wherein the power transmission unit is positioned between an outer end portion of the transport roller pulley and an outer end portion of the discharge roller pulley in the discharge direction.

Further, in order to solve the above-mentioned problem, another recording apparatus according to the present disclosure includes a recording head attached to a carriage and configured to perform recording on a medium, the carriage being configured to reciprocate, a transport roller configured to transport the medium, a discharge roller configured to discharge the medium on which the recording was performed, a medium reception tray configured to receive the medium being discharged by the discharge roller, the medium reception tray being configured to be in a first state and in a second state in which the medium reception tray is displaced from the first state in a discharge direction of the medium, a motor being a power source of the discharge roller, a power transmission unit configured to be in a power transmission state in which power of the motor is transmitted from the motor to the medium reception tray and a power non-transmission state in which the power of the motor is not transmitted from the motor to the medium reception tray, and a switching lever unit configured to switch between the power non-transmission state and the power transmission state, wherein the power transmission unit includes a power switching mechanism configured to switch between the power non-transmission state and the power transmission state by the switching lever unit, and the power switching mechanism is positioned between an outer end portion of the motor and an outer end portion of the transport roller in the discharge direction.

### BRIEF DESCRIPTION OF THE DRAWINGS

FIG. 1 is a schematic view of a recording apparatus of an embodiment of the present disclosure.

FIG. 2 is a side cross-sectional view illustrating an internal configuration of the recording apparatus in FIG. 1, and is a view illustrating a part thereof in an enlarged manner.

FIG. 3 is a plan cross-sectional view illustrating the internal configuration of the recording apparatus in FIG. 1, and is a view illustrating a part thereof in an enlarged manner from a different angle.

FIG. 4 is a plan cross-sectional view illustrating a periphery of a power transmission unit of the recording apparatus in FIG. 1.

FIG. 5 is a plan cross-sectional view illustrating the periphery of the power transmission unit of the recording apparatus in FIG. 1, and is a view from which the motor is omitted.

FIG. 6 is a side cross-sectional view illustrating the periphery of the power transmission unit of the recording apparatus in FIG. 1.

FIG. 7 is a perspective view illustrating the power transmission unit and the motor of the recording apparatus in FIG. 1.

FIG. 8 is a perspective view illustrating the power transmission unit and a carriage of the recording apparatus in FIG. 1, and is a view illustrating a state in which, within a reciprocating range, the carriage is on a side close to the power transmission unit, and a switching lever unit is at a non-contact position.

FIG. 9 is a perspective view illustrating the power transmission unit, the carriage, and a medium reception tray of the recording apparatus in FIG. 1, and is a view illustrating a state in which, within the reciprocating range, the carriage is on the side close to the power transmission unit, and the switching lever unit is at a contact position.

FIG. 10 is a perspective view illustrating the power transmission unit, the carriage, and the medium reception tray of the recording apparatus in FIG. 1, and is a view illustrating a state in which, within the reciprocating range, the carriage is at a home position on a side opposite to the side close to the power transmission unit.

FIG. 11 is a perspective view of the power transmission unit of the recording apparatus in FIG. 1, and is a view illustrating a state in which the switching lever unit is at the contact position.

FIG. 12 is a perspective view of the power transmission unit of the recording apparatus in FIG. 1, which is viewed from an angle different from FIG. 11, and is a view illustrating a state in which the switching lever unit is at the non-contact position.

FIG. 13 is a perspective view illustrating a state in which the switching lever unit of the recording apparatus in FIG. 1 is shifted from a state of being at the non-contact position to a state of being at the contact position.

FIG. 14 is a perspective view illustrating a state in which the switching lever unit of the recording apparatus in FIG. 1 is shifted from the state of being at the non-contact position to the state of being at the contact position, and the switching lever unit further slides.

FIG. 15 is a front cross-sectional view illustrating a state in which the switching lever unit of the recording apparatus in FIG. 1 is shifted from the state of being at the non-contact position to the state of being at the contact position, and the switching lever unit further slides.

FIG. 16 is a perspective cross-sectional view illustrating a state in which the switching lever unit of the recording apparatus in FIG. 1 is shifted from the state of being at the non-contact position to the state of being at the contact position, and the switching lever unit further slides.

FIG. 17 is a perspective view illustrating a periphery of a lock component and a transmission component of the power transmission unit of the recording apparatus in FIG. 1.

FIG. 18 is a perspective view of the periphery of the lock component and the transmission component of the power transmission unit of the recording apparatus in FIG. 1, which is viewed from an angle different from FIG. 17.

FIG. 19 is a perspective view of the periphery of the lock component and the transmission component of the power transmission unit of the recording apparatus in FIG. 1, which is viewed from an angle different from FIG. 17 and FIG. 18.

FIG. 20 is a perspective cross-sectional view of the power transmission unit of the recording apparatus in FIG. 1, and is a view illustrating a state in which the switching lever unit is at the contact position.

FIG. 21 is a perspective view illustrating a periphery of a friction toothed gear of the power transmission unit of the recording apparatus in FIG. 1.

FIG. 22 is a perspective cross-sectional view illustrating the periphery of the friction toothed gear of the power transmission unit of the recording apparatus in FIG. 1.

FIG. 23 is a perspective view illustrating the power transmission unit and the carriage of the recording apparatus in FIG. 1, and is a view illustrating arrangement of the switching lever unit with respect to the carriage when, within the reciprocating range, the carriage is on the side close to the power transmission unit, and the switching lever unit is at the non-contact position.

FIG. 24 is a view obtained by omitting the switching lever unit from FIG. 23.

FIG. 25 is a perspective view illustrating a unit including the power transmission unit of the recording apparatus in FIG. 1.

FIG. 26 is a perspective view obtained by omitting a second frame from the unit including the power transmission unit of the recording apparatus in FIG. 1.

FIG. 27 is a perspective view obtained by omitting the power transmission unit and the second frame from the unit including the power transmission unit of the recording apparatus in FIG. 1, in other words, a perspective view illustrating a first frame.

FIG. 28 is a perspective view illustrating a main body frame to which the unit including the power transmission unit of the recording apparatus in FIG. 1 is attached.

### DESCRIPTION OF EMBODIMENTS

First, the present disclosure is schematically described below.

In order to solve the above-mentioned problem, a recording apparatus according to a first aspect of the present disclosure includes a recording head attached to a carriage and configured to perform recording on a medium, the carriage being configured to reciprocate, a transport roller configured to transport the medium, a discharge roller configured to discharge the medium on which the recording was performed, a medium reception tray configured to receive the medium being discharged by the discharge roller, the medium reception tray being configured to be in a first state and a second state in which the medium reception tray is displaced from the first state in a discharge direction of the medium, a motor being a power source of the discharge roller, a power transmission unit configured to be in a power transmission state in which power of the motor is transmitted from the motor to the medium reception tray and a power non-transmission state in which the power of the motor is not transmitted from the motor to the medium reception tray, and a belt being stretched around a transport roller pulley provided to the transport roller and a discharge roller pulley provided to the discharge roller, wherein the power transmission unit is positioned between an outer end portion of the transport roller pulley and an outer end portion of the discharge roller pulley in the discharge direction.

According to the present aspect, the power transmission unit is positioned between the outer end portion of the transport roller pulley and the outer end portion of the discharge roller pulley in the discharge direction. When the power transmission unit is arranged on the distal end side in the discharge direction with respect to the discharge roller pulley, the apparatus as a whole is likely to protrude to the distal end side in the discharge direction. When the power transmission unit is arranged on the rear end side in the discharge direction with respect to the transport pulley, the apparatus as a whole is likely to protrude to the rear end side in the discharge direction. However, when the power transmission unit is arranged as described above, the length of the recording apparatus as a whole in the discharge direction can be reduced. Therefore, the recording apparatus including the medium reception tray that can be displaced in the first state and the second state can be reduced in size.

In a recording apparatus according to a second aspect of the present disclosure, which is an aspect dependent on the first aspect, the power transmission unit is positioned on an inner side closer to the center of the recording apparatus in a reciprocating direction of the carriage than a routing range of the belt.

According to the present aspect, the power transmission unit is positioned on an inner side closer to the center of the recording apparatus in a reciprocating direction of the carriage than a routing range of the belt. When the power transmission unit is positioned on the outer side of the recording apparatus in the reciprocating direction of the carriage with respect to the routing range of the belt, the apparatus as a whole is likely to protrude in the reciprocating direction of the carriage. However, with the configuration described above, the length of the recording apparatus as whole in the reciprocating direction of the carriage can be reduced. Therefore, the recording apparatus including the medium reception tray that can be displaced in the first state and the second state can particularly be reduced in size.

In a recording apparatus according to a third aspect of the present disclosure, which is an aspect dependent on the first aspect or the second aspect, the power transmission unit is positioned around the motor as viewed in a direction along the reciprocating direction of the carriage.

According to the present aspect, the power transmission unit is positioned around the motor as viewed in the direction along the reciprocating direction of the carriage. In other words, the power transmission unit is arranged while bypassing the motor. Thus, the power transmission unit can be prevented from interfering with the motor.

A recording apparatus according to a fourth aspect of the present disclosure includes a recording head attached to a carriage and configured to perform recording on a medium, the carriage being configured to reciprocate, a transport roller configured to transport the medium, a discharge roller configured to discharge the medium on which the recording was performed, a medium reception tray configured to receive the medium being discharged by the discharge roller, the medium reception tray being configured to be in a first state and in a second state in which the medium reception tray is displaced from the first state in a discharge direction of the medium, a motor being a power source of the discharge roller, a power transmission unit configured to be in a power transmission state in which power of the motor is transmitted from the motor to the medium reception tray and a power non-transmission state in which the power of the motor is not transmitted from the motor to the medium reception tray, and a switching lever unit configured to switch between the power non-transmission state and the power transmission state, wherein the power transmission unit includes a power switching mechanism configured to switch between the power non-transmission state and the power transmission state by the switching lever unit, and the power switching mechanism is positioned between an outer end portion of the motor and an outer end portion of the transport roller in the discharge direction.

According to the present aspect, the power transmission unit includes the power switching mechanism configured to switch between the power non-transmission state and the power transmission state by the switching lever unit, and the power switching mechanism is positioned between the outer end portion of the motor and the outer end portion of the transport roller in the discharge direction. When the power switching mechanism is arranged on the distal end side in the discharge direction with respect to the outer end portion of the motor, the apparatus as a whole is likely to protrude to the distal end side in the discharge direction. When the power switching mechanism is arranged on the rear end side in the discharge direction with respect to the outer end portion of the transport roller, the apparatus as a whole is likely to protrude to the rear end side in the discharge direction. However, when the power switching mechanism is arranged as described above, the length of the recording apparatus as a whole in the discharge direction can be reduced. Therefore, the recording apparatus including the medium reception tray that can be displaced in the first state and the second state can be reduced in size.

In a recording apparatus according to a fifth aspect of the present disclosure, which is an aspect dependent on the fourth aspect, the power switching mechanism overlaps the motor in at least one of the reciprocating direction of the carriage and an intersection direction intersecting with both the discharge direction and the reciprocating direction of the carriage.

According to the present aspect, the power switching mechanism overlaps the motor in at least one of the reciprocating direction of the carriage and the intersection direction. Thus, in at least one of the reciprocating direction of the carriage or the intersection direction, the power switching mechanism can be arranged efficiently with respect to the motor. As a result, the recording apparatus including the medium reception tray that can be displaced in the first state and the second state can particularly be reduced in size.

In a recording apparatus according to a sixth aspect of the present disclosure, which is an aspect dependent on the fourth aspect or the fifth aspect, the power switching mechanism overlaps a final stage of a driving wheel train of the power transmission unit in an intersection direction intersecting with both the discharge direction and the reciprocating direction of the carriage.

According to the present aspect, the power switching mechanism overlaps the final stage of the driving wheel train of the power transmission unit in the intersection direction intersecting with both the discharge direction and the reciprocating direction of the carriage. With this configuration, in the intersection direction, the power switching mechanism can be arranged efficiently with respect to the driving wheel train of the power transmission unit. As a result, the recording apparatus including the medium reception tray that can be displaced in the first state and the second state can particularly be reduced in size.

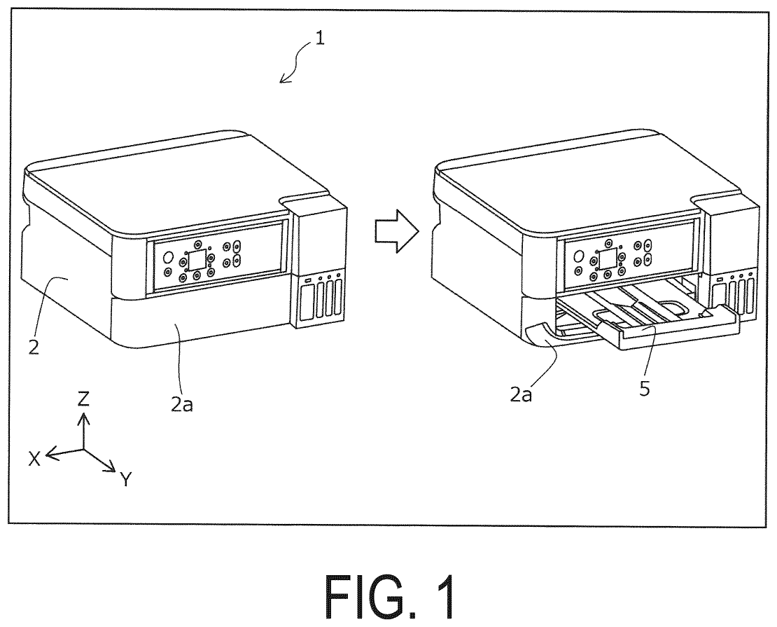

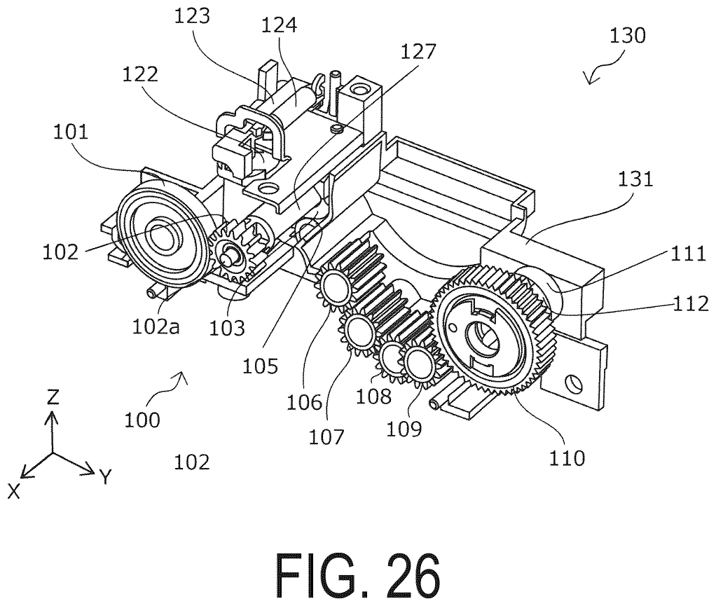

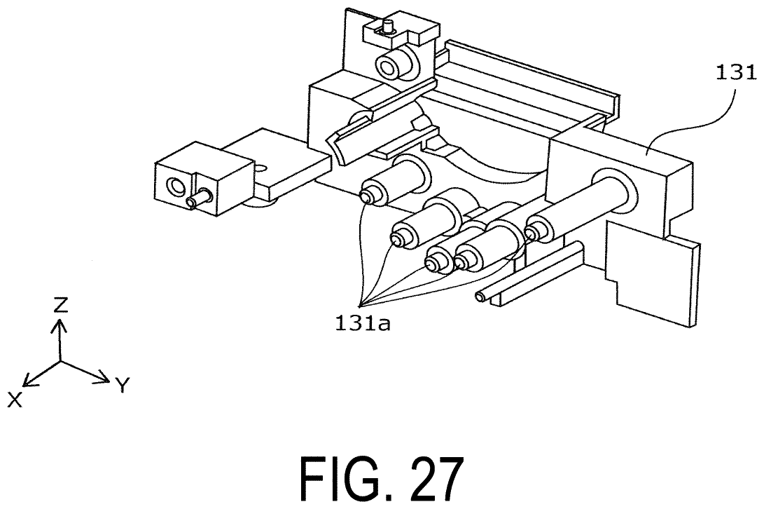

With reference to FIG. 1 to FIG. 28, the recording apparatus 1 of the embodiment of the present disclosure is specifically described below. In the following description, three axes that are orthogonal to each other are referred to as an X axis, a Y axis, and a Z axis, respectively, as illustrated in each of the drawings. The Z axis direction corresponds to a vertical direction, in other words, a direction in which gravity acts. The X axis direction and the Y axis direction correspond to horizontal directions. In each of the drawings, directions indicated by the arrows of the three axes (X, Y, and Z) are +directions of the respective directions. For example, the X axis direction corresponds to a reciprocating direction of a carriage 3, a +X direction corresponds to a side on which a power transmission unit 100 is provided, and a-X direction corresponds to a side close to a home position of the carriage 3. Further, a +Y direction corresponds to a discharge direction of a medium reception tray 5.

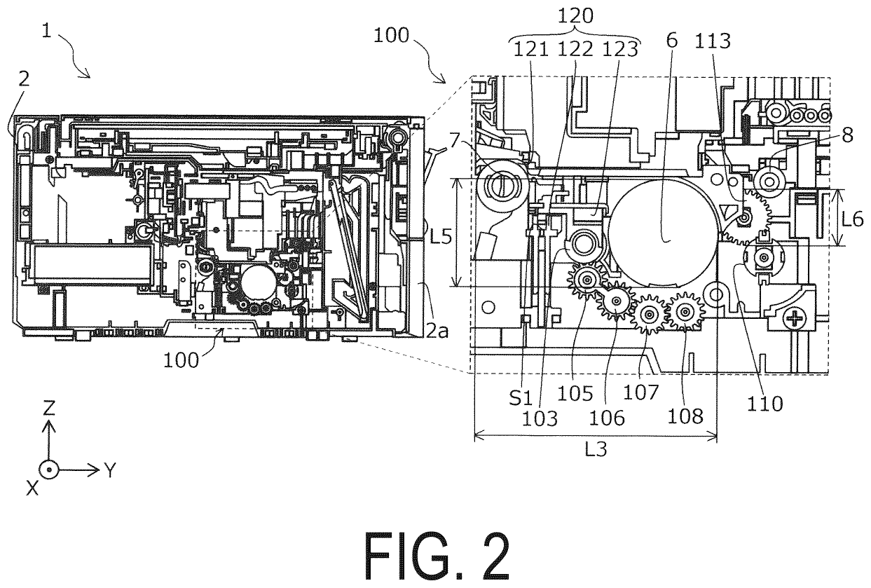

As illustrated in FIG. 1, the recording apparatus 1 of the present embodiment includes a casing 2. Further, as a part of the casing 2, a front cover 2a is provided. The recording apparatus 1 of the present embodiment can be displaced from the left part in FIG. 1 to the right part in FIG. 1. Specifically, the recording apparatus 1 is configured so that the medium reception tray 5 can be switched between a first state being an accommodation state and a second state being an extension state by the motor 6 illustrated in FIG. 2 or the like.

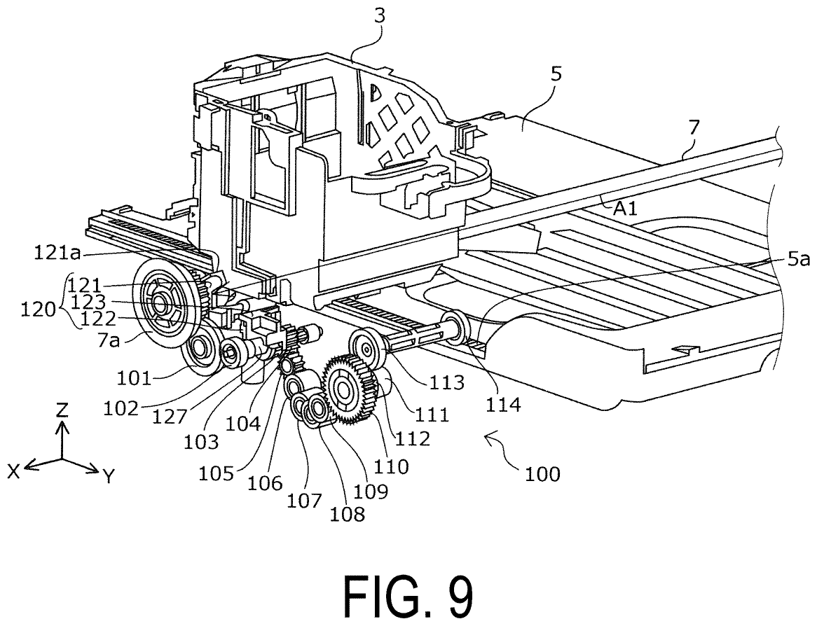

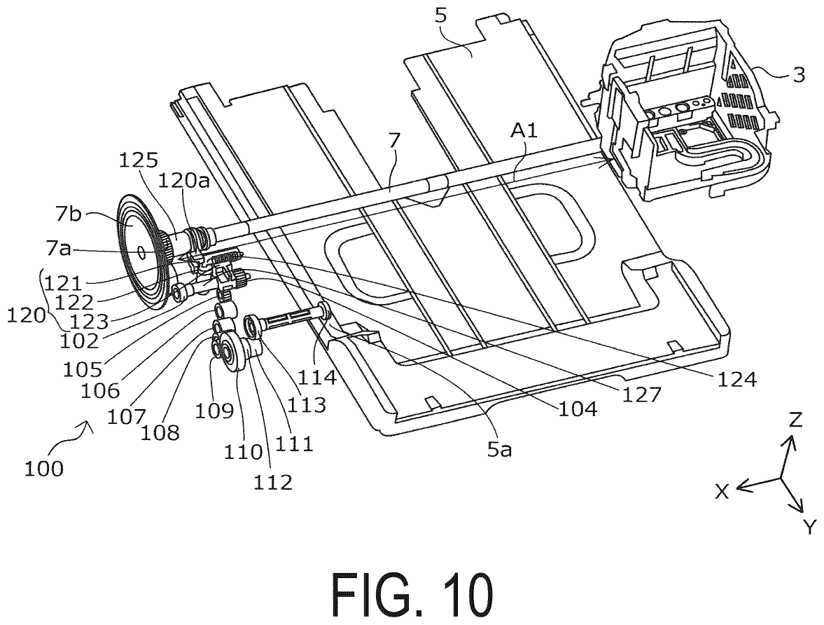

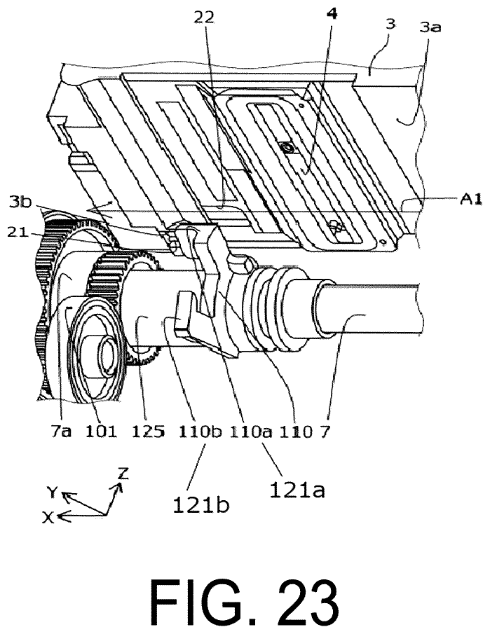

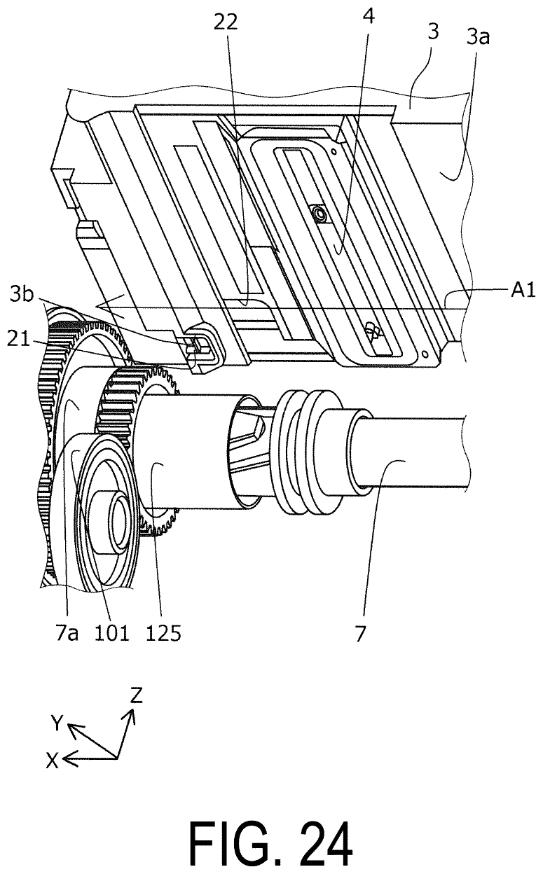

Herein, the recording apparatus 1 of the present embodiment includes, inside the casing 2, the carriage 3 that reciprocates along the X axis direction as illustrated in FIG. 9, FIG. 10, and the like, and a recording head 4 that is attached to the carriage 3 and performs recording on a medium as illustrated in FIG. 23 and FIG. 24. Further, the recording apparatus 1 of the present embodiment includes, inside the casing 2, a transport roller 7 that transports a medium and a discharge roller 8 that discharges the medium after recording, as illustrated in FIG. 2 and the like. Further, the recording apparatus 1 of the present embodiment includes, inside the casing 2, the medium reception tray 5 that receives the medium discharged by the discharge roller 8 as illustrated in FIG. 9, FIG. 10, and the like, and a motor 6 being a power source of the transport roller 7 and the discharge roller 8 as illustrated in FIG. 2 and the like.

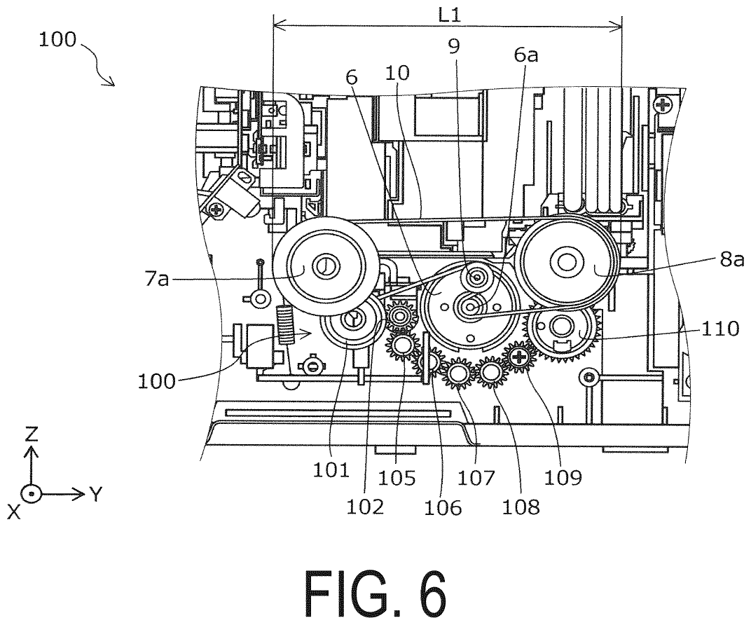

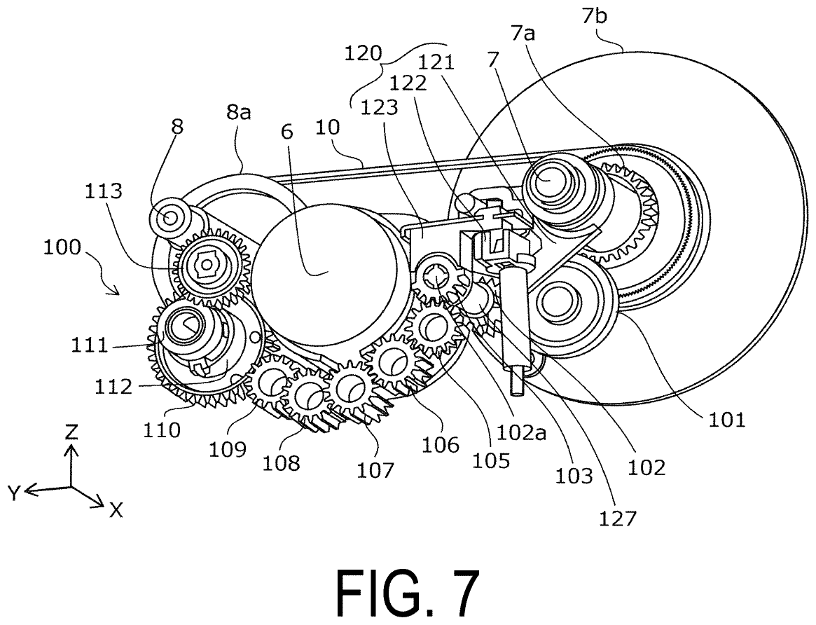

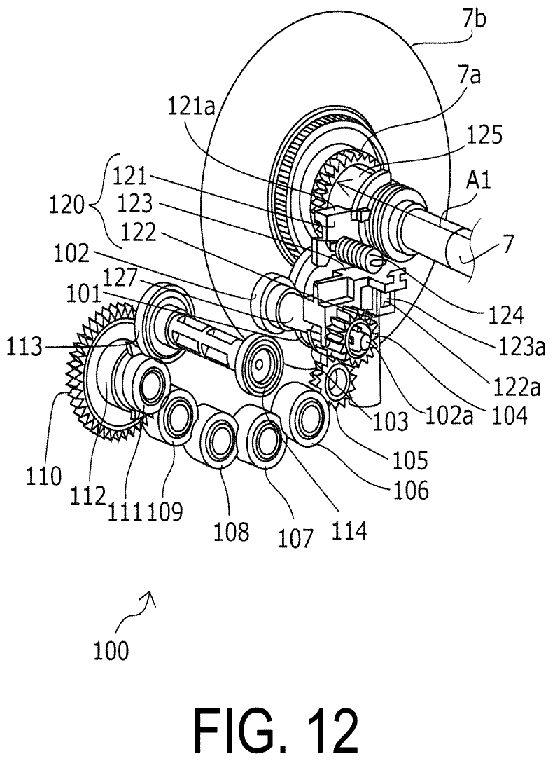

Transmission of power from the motor 6 to the transport roller 7 and the discharge roller 8 is performed in the following manner. As illustrated in FIG. 6, a motor pulley 6a is attached to the motor 6. A belt 10 is stretched around the motor pulley 6a. In addition to the motor pulley 6a, the belt 10 is stretched around a transport pulley 7a provided to the transport roller 7, a discharge roller pulley 8a provided to the discharge roller 8, and a pulley 9. As the rotation shaft of the motor 6 rotates, the motor pulley 6a rotates. With this, the belt 10 rotates. Further, the transport roller 7 and the discharge roller 8 rotate as the transport pulley 7a and the discharge roller pulley 8a rotate. Note that, as illustrated in FIG. 7, FIG. 12, and the like, the transport roller 7 is provided with an encoder 7b that measures rotation of the transport roller 7.

Herein, as described above, the medium reception tray 5 may be in the first state being the accommodation state and the second state being the extension state displaced in the discharge direction of the medium from the first state. Moreover, as illustrated in FIG. 2 and the like, the recording apparatus 1 of the present embodiment includes, inside the casing 2, the power transmission unit 100. Herein, the power transmission unit 100 may be in a power transmission state of transmitting the power of the motor 6 from the motor 6 to the medium reception tray 5 and a power non-transmission state of not transmitting the power of the motor 6 from the motor 6 to the medium reception tray 5.

Herein, the power transmission unit 100 is described. As illustrated in FIG. 7 to FIG. 12 and the like, the power transmission unit 100 includes a toothed gear 101 engaged with the transport pulley 7a. The toothed gear 101 is engaged with a toothed gear 102, and a rotation shaft 102a of the toothed gear 102 is provided with a lock component 103 being a D-shaped toothed gear and a transmission component 104 being a toothed gear. The rotation shaft 102a of the toothed gear 102, the lock component 103, and the transmission component 104 is a direction along the X axis direction, and the lock component 103 and the transmission component 104 are configured to move integrally along the X axis direction by a power switching mechanism 120. Note that, although details of the power switching mechanism 120 are described later, the lock component 103 is configured not to rotate by interfering with a holding member 123 forming a part of the power switching mechanism 120, and the transmission component 104 is configured to rotate as the toothed gear 102 rotates.

Further, as illustrated in FIG. 7 to FIG. 12 and the like, the power transmission unit 100 includes a toothed gear 105. Thus, when the power switching mechanism 120 moves the lock component 103 and the transmission component 104 along the X axis direction, the toothed gear 105 and the lock component 103 can be engaged with each other, and the toothed gear 105 and the transmission component 104 can be engaged with each other. Note that, with the configuration described above, in a case in which the toothed gear 102 rotates, when the toothed gear 105 and the lock component 103 are engaged with each other, the toothed gear 105 does not rotate. When the toothed gear 105 and the transmission component 104 are engaged with each other, the toothed gear 105 rotates.

Further, as illustrated in FIG. 7 to FIG. 12 and the like, the toothed gear 105 is engaged with a toothed gear 106, the toothed gear 106 is engaged with a toothed gear 107, the toothed gear 107 is engaged with a toothed gear 108, and the toothed gear 108 is engaged with a toothed gear 109. The toothed gear 109 is engaged with a toothed gear 110. The toothed gear 110 is engaged with a toothed gear 111, which shares the same rotary shaft, via a friction forming portion 112. In other words, the toothed gear 110, the toothed gear 111, and the friction forming portion 112 form a friction toothed gear. Further, the toothed gear 111 is engaged with a toothed gear 113 being a final stage of a driving wheel train of the power transmission unit 100. The toothed gear 113 is configured to be rotatable with a pinion 114, which shares the same rotary shaft, and the pinion 114 is engaged with a rack 5a formed on the medium reception tray 5. Thus, as the toothed gear 113 rotates, the medium reception tray 5 is movable along the Y axis direction. In this manner, the power transmission unit 100 of the present embodiment includes the power switching mechanism 120 and the driving wheel train from the toothed gear 101 to the toothed gear 113.

Herein, in the recording apparatus 1 of the present embodiment, as illustrated in FIG. 6, the power transmission unit 100 is positioned in a region L1 between an outer end portion of the transport pulley 7a and an outer end portion of the discharge roller pulley 8a in the Y axis direction corresponding to the discharge direction of the medium. When the power transmission unit 100 is arranged on the distal end side in the discharge direction with respect to the discharge roller pulley 8a, the apparatus as a whole is likely to protrude to the +Y direction being the distal end side in the discharge direction. When the power transmission unit 100 is arranged in the −Y direction being the rear end side in the discharge direction with respect to the transport pulley 7a, the apparatus as a whole is likely to protrude to the rear end side in the discharge direction. However, when the power transmission unit 100 is arranged as described above, the length of the recording apparatus 1 as a whole in the discharge direction can be reduced. Therefore, according to the recording apparatus 1 of the present embodiment, size reduction of the recording apparatus including the medium reception tray 5 that can be displaced in the first state and the second state is achieved.

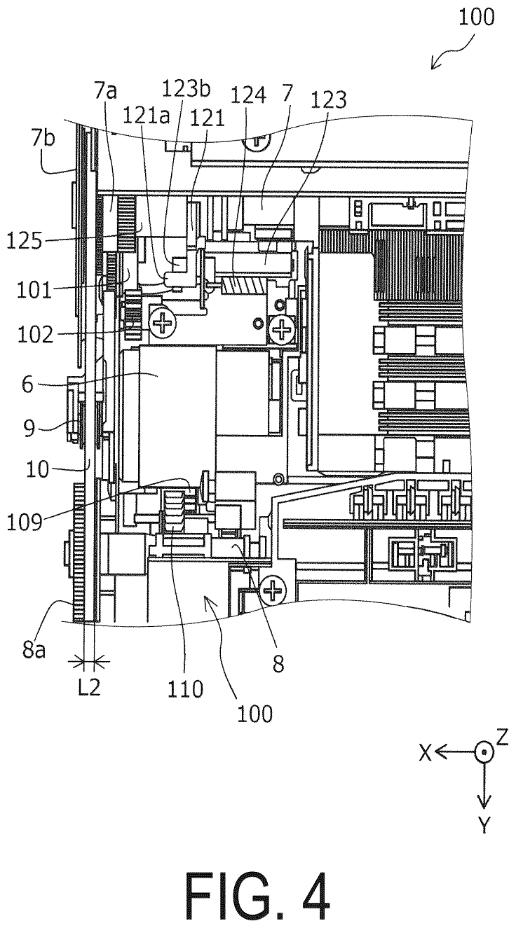

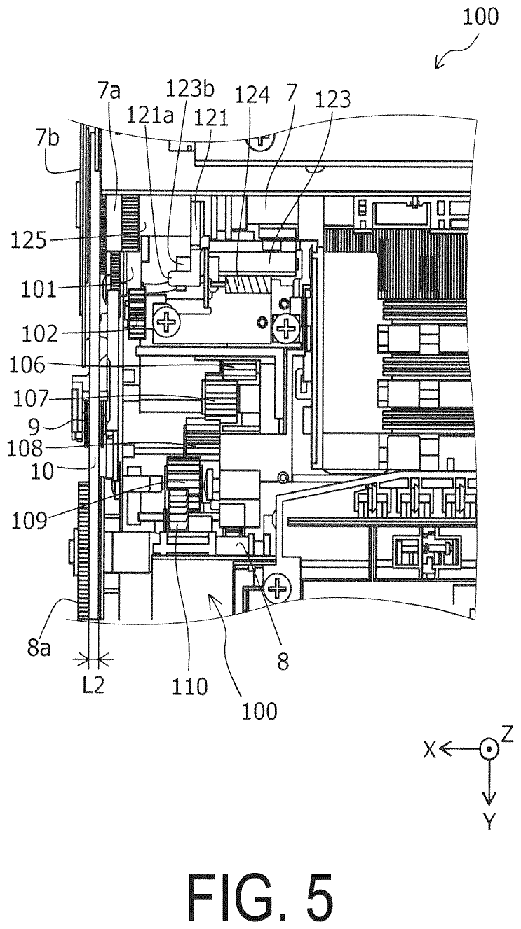

Further, as illustrated in FIG. 4 and FIG. 5, the power transmission unit 100 of the present embodiment is positioned on the inner side close to the center of the recording apparatus 1, in other words, on the −X direction side in FIG. 4 and FIG. 5 in the X axis direction corresponding to the reciprocating direction of the carriage 3 with respect to a routing range L2 of the belt 10. When the power transmission unit 100 is positioned on the outer side of the recording apparatus 1 in the reciprocating direction of the carriage 3 with respect to the routing range of the belt 10, the apparatus as a whole is likely to protrude in the reciprocating direction of the carriage 3. However, with the configuration described above, the length of the recording apparatus 1 as whole in the reciprocating direction of the carriage 3 can be reduced. Therefore, according to the recording apparatus 1 of the present embodiment, size reduction of the recording apparatus including the medium reception tray 5 that can be displaced in the first state and the second state is particularly achieved.

Further, as illustrated in FIG. 6, the power transmission unit 100 of the present embodiment is positioned in the periphery of the motor 6 as viewed in the direction along the reciprocating direction of the carriage 3. In other words, the power transmission unit 100 is arranged while bypassing the motor 6. Thus, the recording apparatus 1 of the present embodiment prevents the power transmission unit 100 from interfering with the motor 6.

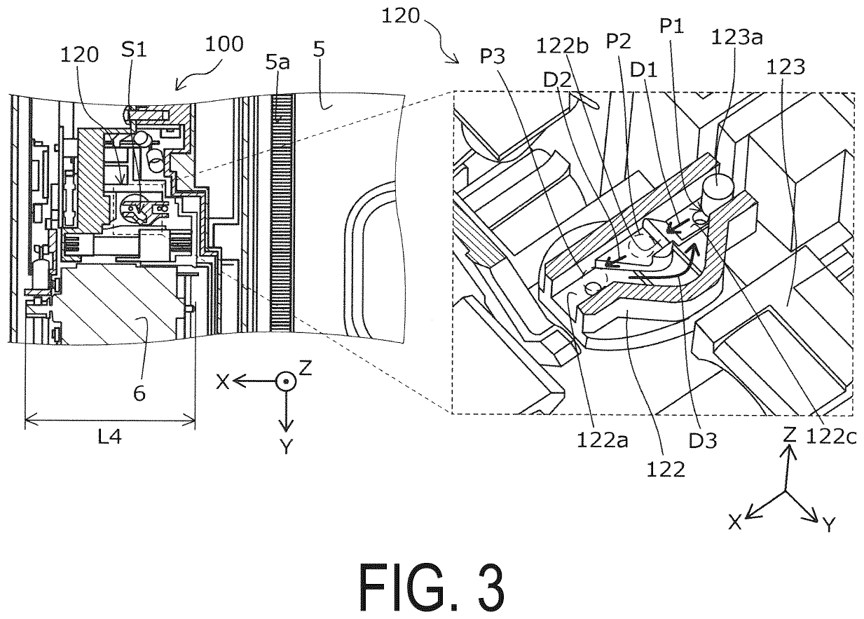

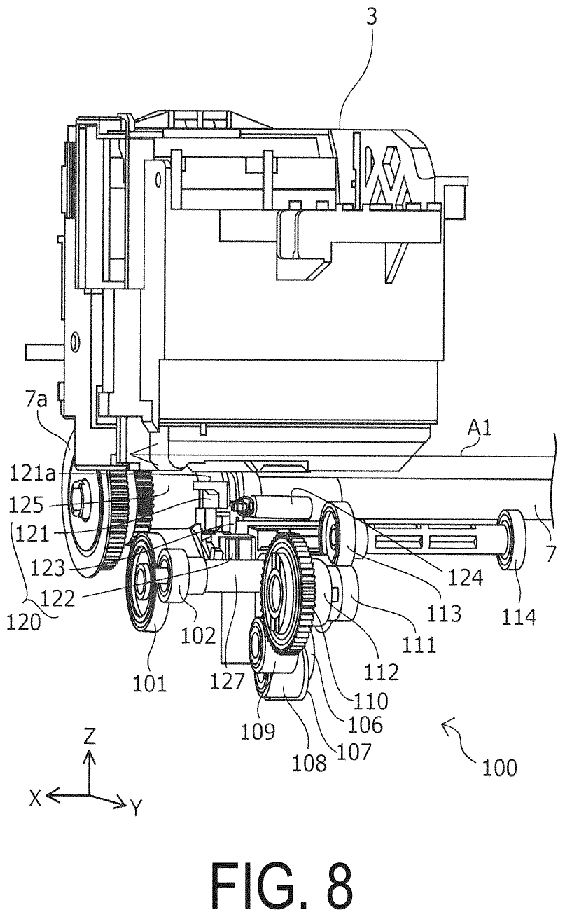

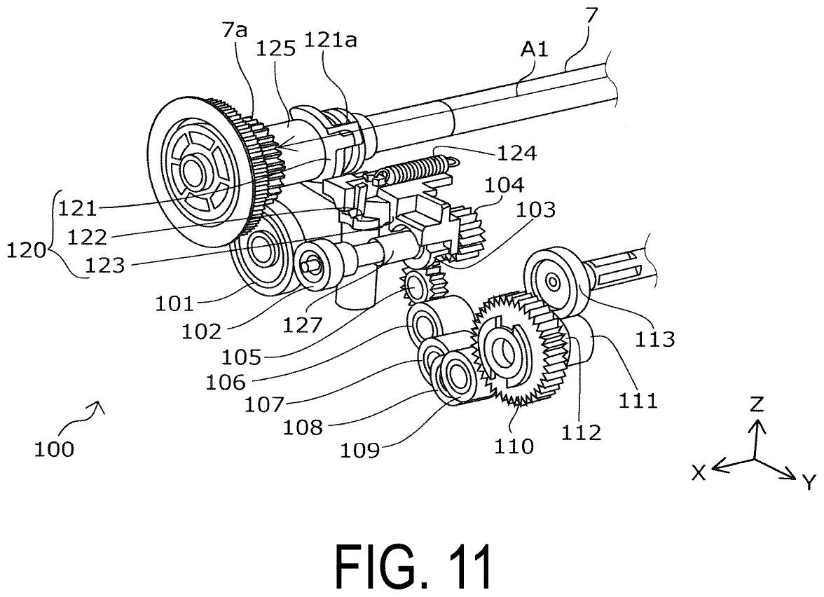

Next, in view of arrangement of the power switching mechanism 120, the recording apparatus 1 of the present embodiment is described. As illustrated in FIG. 8 to FIG. 12, the recording apparatus 1 of the present embodiment includes a switching lever unit 121, a cam 122, and the holding unit 123 as the power switching mechanism 120. The switching lever unit 121 switches the power transmission unit 100 between the power transmission state and the power non-transmission state. As illustrated in FIG. 3, the cam 122 includes a cam surface 122a. The holding unit 123 holds the lock component 103 and the transmission component 104 as illustrated in FIG. 11 and the like, where a pin 123a is arranged on the cam surface 122a as illustrated in FIG. 3. Further, although details are described later, the power switching mechanism 120 can switch between the power non-transmission state and the power transmission state by the switching lever unit 121. Further, as illustrated in FIG. 2, the power switching mechanism 120 is positioned in a region L3 between an outer end portion of the motor 6 and the outer end portion of the transport roller 7 in the Y axis direction corresponding to the discharge direction of the medium. Note that, for example, the position of the power switching mechanism 120 may be a position S1 being a contact position between the cam surface 122a and the pin 123a, which is illustrated in FIG. 3.

When the power switching mechanism 120 is arranged on the distal end side (the +Y direction) with respect to the outer end portion of the motor 6, the apparatus as a whole is likely to protrude to the distal end side in the discharge direction (the +Y direction). When the power switching mechanism 120 is arranged on the rear end side in the discharge direction (the −Y direction) with respect to the outer end portion of the transport roller 7, the apparatus as a whole is likely to protrude to the rear end side in the discharge direction (the −Y direction). However, when the power switching mechanism 120 is arranged in this manner, the length of the recording apparatus 1 as whole in the discharge direction (the Y axis direction) can be reduced. Therefore, according to the recording apparatus 1 of the present embodiment, size reduction of the recording apparatus including the medium reception tray 5 that can be displaced in the first state and the second state is achieved.

Further, as illustrated in FIG. 3, the position S1 of the power switching mechanism 120 of the present embodiment overlaps an occupied range L4 of the motor 6 in the reciprocating direction of the carriage 3 (the X axis direction). Moreover, as illustrated in FIG. 2, the position S1 of the power switching mechanism 120 of the present embodiment overlaps an occupied range L5 of the motor 6 in the Z axis direction corresponding to the intersecting direction that intersects both the discharge direction (the Y axis direction) and the reciprocating direction of the carriage (the X axis direction).

In this manner, the power switching mechanism 120 may overlap the motor 6 in at least one of the reciprocating direction of the carriage 3 (the X axis direction) or the intersection direction (the Z axis direction). With this configuration, in at least one of the reciprocating direction of the carriage 3 (the X axis direction) or the intersection direction (the Z axis direction), the power switching mechanism 120 can be arranged efficiently with respect to the motor 6. As a result, the recording apparatus including the medium reception tray 5 that can be displaced in the first state and the second state can particularly be reduced in size.

Further, as illustrated in FIG. 2, the position S1 of the power switching mechanism 120 of the present embodiment overlaps an occupied range L6, which is the toothed gear 113 being the final stage of the driving wheel train of the power transmission unit 100, in the intersection direction (the Z axis direction). The power switching mechanism 120 of the present embodiment is thus configured. Thus, in the intersection direction (the Z axis direction), the power switching mechanism 120 can be arranged efficiently with respect to the driving wheel train of the power transmission unit 100. Thus, the recording apparatus 1 of the present embodiment including the medium reception tray 5 that can be displaced in the first state and the second state can particularly be reduced in size.

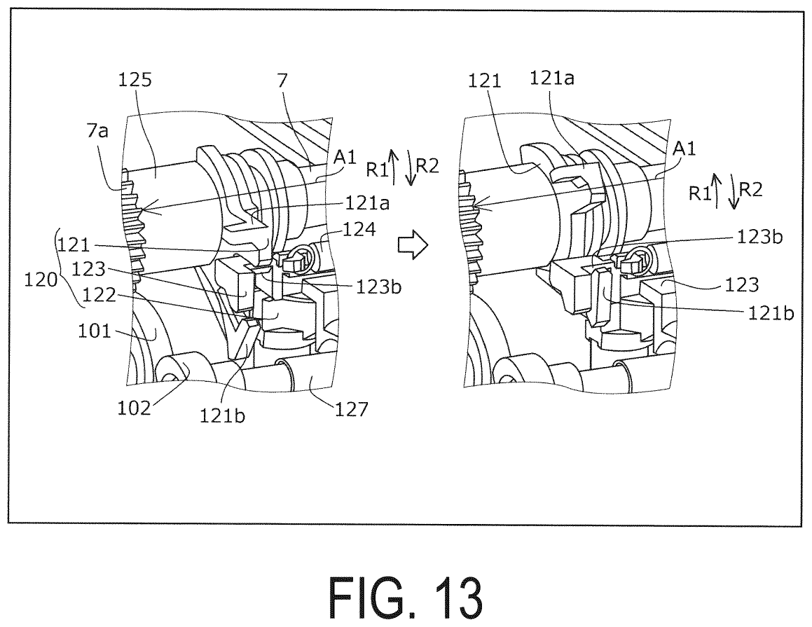

An operation of the power transmission unit 100, particularly, the switching lever unit 121 of the power switching mechanism 120, an accompanying operation of the driving wheel train of the power transmission unit 100, and a relationship with an operation of the carriage 3 are described below. As illustrated in FIG. 8, FIG. 9, and the like, the switching lever unit 121 is provided in the X axis direction within a reciprocating range A1 of the carriage 3. The reciprocating range A1 of the carriage 3 indicates a presence region of the carriage 3 as the carriage 3 reciprocates. The switching lever unit 121 is configured to rotate between a contact position and a non-contact position. As illustrated in FIG. 9, the right part in FIG. 13, and the like, at the contact position, a distal end portion 121a being a part of the switching lever unit 121 can contact with the carriage 3 as the carriage 3 reciprocates. As illustrated in FIG. 8, the left part in FIG. 13, and the like, at the non-contact position, any part of the switching lever unit 121 does not contact with the carriage 3 even when the carriage 3 moves. Specifically, the motor 6 rotates in a forward rotation direction being a rotation direction at the time of transporting the medium, and the transport roller 7 rotates a rotation direction R1 in FIG. 13. With this, the switching lever unit 121 is shifted from the non-contact position in the left side state in FIG. 13, which is an initial state, to the contact position in the right side state in FIG. 13. Note that, in the initial state, the switching lever unit 121 is biased in a rotation direction R2.

As illustrated in FIG. 13, the switching lever unit 121 includes the distal end portion 121a and an engaging portion 121b. The distal end portion 121a enters or exits from the reciprocating range A1 of the carriage 3 by rotating. At the non-contact position, the engaging portion 121b is not engaged with an engaged portion 123b of the holding unit 123. At the contact position, the engaging portion 121b is engaged with the engaged portion 123b of the holding unit 123. Herein, the switching lever unit 121 is urged to the −X direction side by an elastic member 125, and the holding unit 123 is biased to the −X direction side by a coil sprint 124. However, when the switching lever unit 121 is at the contact position, the switching lever unit 121 contacts with the carriage 3 and slides in the +X direction as the carriage 3 reciprocates. With this, the holding unit 123 slides in the +X direction together with the switching lever unit 121. Further, when the holding unit 123 slides in the +X direction together with the switching lever unit 121, the power transmission unit 100 is switched between the power non-transmission state and the power transmission state.

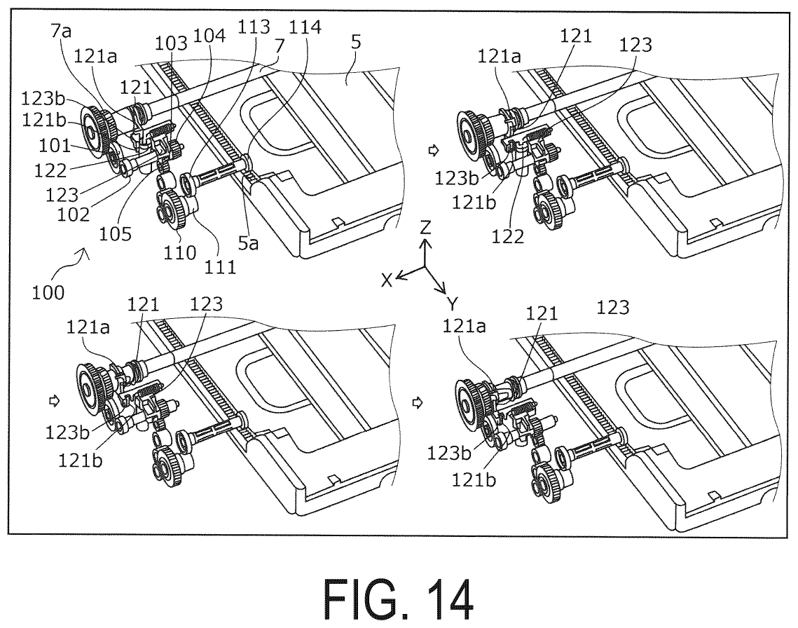

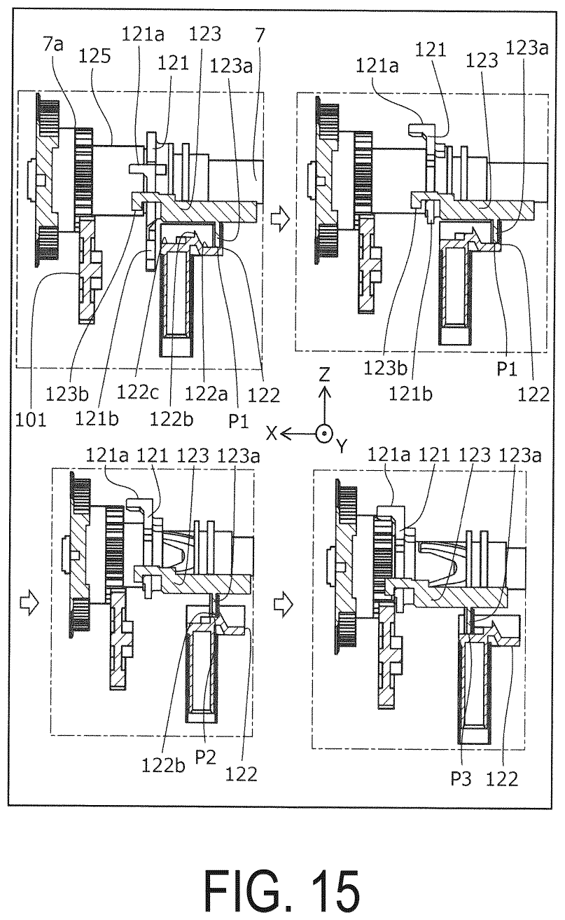

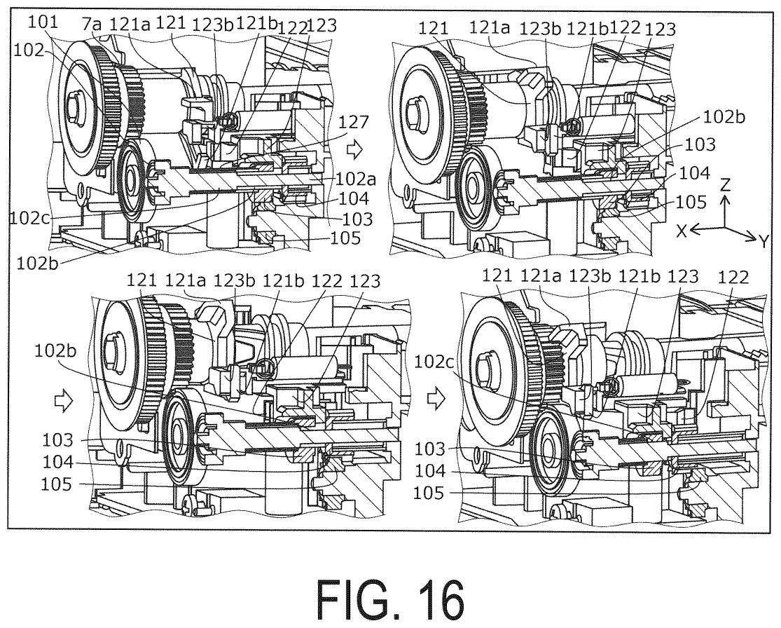

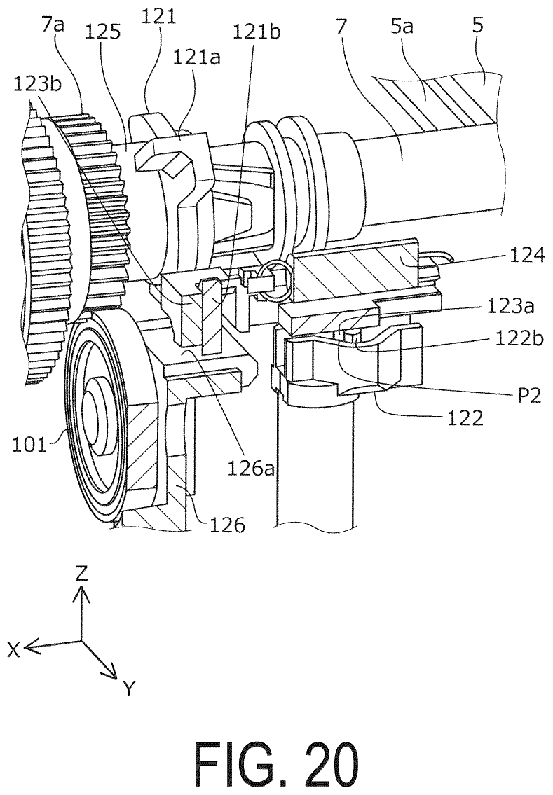

With reference to FIG. 3, FIG. 14, FIG. 15, FIG. 16, and FIG. 20, a procedure of switching the power transmission unit 100 from the power non-transmission state to the power transmission state is described below. All of FIG. 14, FIG. 15, and FIG. 16 illustrate a state in which the power transmission unit 100 is switched from the power non-transmission state to the power transmission state. All of the upper left parts in FIG. 14, FIG. 15, and FIG. 16 correspond to the left part in FIG. 13, and illustrate a state in which the switching lever unit 121 is at the non-contact position, which is the initial state. Note that, in this state, the position of the pin 123a of the holding unit 123 with respect to the cam surface 122a of the cam 122 is a first position P1 in FIG. 3.

Next, the motor 6 rotates in the forward direction, and thus the state is shifted from the state in the upper left parts in FIG. 14, FIG. 15, and FIG. 16 to the state in the upper right parts in FIG. 14, FIG. 15, and FIG. 16. This corresponds to the shift from the state corresponding to the left part in FIG. 13 to the right part in FIG. 13 when the switching lever unit 121 rotates. Specifically, the switching lever unit 121 rotates in the rotation direction R1, the distal end portion 121a enters the reciprocating range A1 of the carriage 3, and the engaging portion 121b is engaged with the engaged portion 123b. Note that, in this state, the position of the pin 123a of the holding unit 123 with respect to the cam surface 122a of the cam 122 is also the first position P1 in FIG. 3. Herein, in the state in the upper left parts in FIG. 14, FIG. 15, and FIG. 16 and the upper right parts in FIG. 14, FIG. 15, and FIG. 16, the toothed gear 105 and the lock component 103 are engaged with each other, and the power transmission unit 100 is in the power non-transmission state.

Next, the distal end portion 121a contacts with the carriage 3, and the switching lever unit 121 is pushed in the +X direction. With this, the state is shifted from the state in the upper right parts in FIG. 14, FIG. 15, and FIG. 16 to the state in the lower left parts in FIG. 14, FIG. 15, and FIG. 16. Note that, in FIG. 14, FIG. 15, and FIG. 16, illustration is given while omitting the carriage 3. Note that, in this state, the position of the pin 123a of the holding unit 123 with respect to the cam surface 122a of the cam 122 is a second position P2 in FIG. 3. The pin 123a moves from the first position P1 to the second position P2 along a movement path D1. At the second position P2 in FIG. 3, a pin holding portion 122b that hooks and holds the pin 123a on the cam surface 122a is formed. Herein, in the state in the lower left parts in FIG. 14, FIG. 15, and FIG. 16, the toothed gear 105 and the transmission component 104 are engaged with each other, and the power transmission unit 100 is in the power transmission state. Further, as illustrated in FIG. 20, when the position of the pin 123a of the holding unit 123, which is illustrated in the state in the lower left parts in FIG. 14, FIG. 15, and FIG. 16, is the second position P2, the engaging portion 121b and the engaged portion 123b are configured to be supported on an upper surface 126a of a support frame 126 of the toothed gear 101. Thus, disengagement between the engaging portion 121b and the engaged portion 123b can be prevented.

Next, the distal end portion 121a contacts with the carriage 3, and the switching lever unit 121 is further pushed in the +X direction. With this, the state is shifted from the state in the lower left parts in FIG. 14, FIG. 15, and FIG. 16 to the state in the lower right parts in FIG. 14, FIG. 15, and FIG. 16. Note that, in this state, the position of the pin 123a of the holding unit 123 with respect to the cam surface 122a of the cam 122 is a third position P3 in FIG. 3. The pin 123a moves from the second position P2 to the third position P3 along a movement path D2. Note that, at the third position P3, a configuration, such as the pin holding portion 122b, for holding the pin 123a is not formed. Thus, as the carriage 3 moves in the −X direction, the position of the pin 123a of the holding unit 123 with respect to the cam surface 122a of the cam 122 returns to the first position P1 by a biasing force of the elastic member 125 acting in the −X direction. The pin 123a moves from the third position P3 to the first position P1 along a movement path D3.

The recording apparatus 1 of the present embodiment is thus configured. As a result, the power switching mechanism 120 and the switching lever unit 121 for switching the power transmission unit 100 between the power-non transmission state and the power transmission state can be arranged suitably, and the mechanism as a whole for switching the medium reception tray 5 between the first state and the second state can be reduced in size. Further, with this, the recording apparatus 1 as a whole can be reduced in size.

Further, as described above, when the switching lever unit 121 of the recording apparatus 1 of the present embodiment is at the contact position, at least the distal end portion 121a enters the reciprocating range A1 of the carriage 3 as described in FIG. 9 and the right part in FIG. 13. At the non-contact position, the distal end portion 121a exits from the reciprocating range A1 of the carriage 3 as illustrated in FIG. 8 and the left part in FIG. 13. In this manner, at the non-contact position in the non-power transmission state, the distal end portion 121a exits from the reciprocating range A1 of the carriage 3. With this, there is no need to provide the switching lever unit 121 outside of the reciprocating range A1 of the carriage 3. As a result, the recording apparatus 1 can particularly be reduced in size.

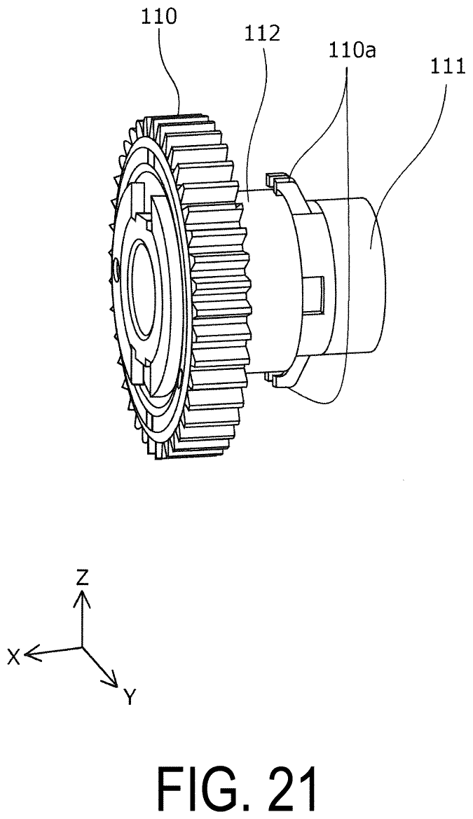

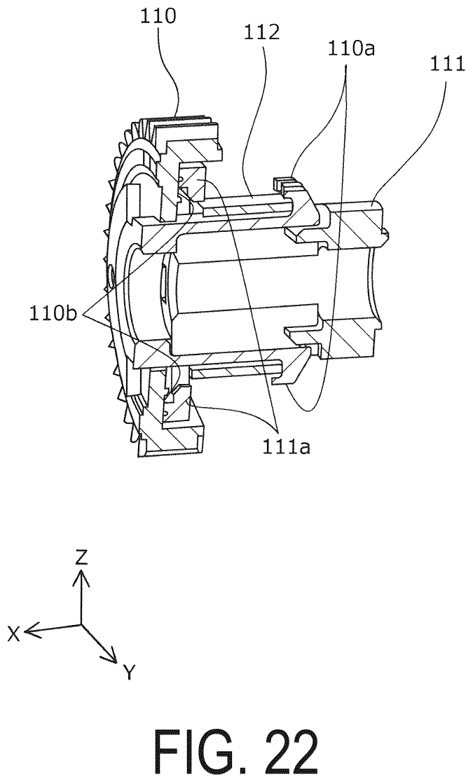

Further, as described above, in the recording apparatus 1 of the present embodiment, the power transmission unit 100 includes the lock component 103 and the transmission component 104. When the power transmission unit 100 is in the power non-transmission state as illustrated in the upper right parts in FIG. 14 and FIG. 16, and the like, the lock component 103 prevents rotation of the toothed gear. When the power transmission unit 100 is in the power transmission state as illustrated in the lower left parts in FIG. 14 and FIG. 16, and the like, the transmission component 104 transmits the power of the motor 6. Further, as apparent from comparison between the upper right parts in FIG. 14 and FIG. 16 and the lower left parts in FIG. 14 and FIG. 16, the switching lever unit 121 switches the coupling of the lock component 103 and the transmission component 104 with respect to of the toothed gear 105 in the power transmission unit 100, by contacting the carriage 3 and sliding in the +X direction. The recording apparatus 1 of the present embodiment is thus configured. Thus, the mechanism that prevents rotation of the toothed gear when being in the power non-transmission state and the mechanism that transmits the power of the motor 6 when being in the power transmission state are formed easily. Further, in the recording apparatus 1 of the present embodiment, when the medium reception tray 5 is manually operated, the friction toothed gear illustrated in FIG. 21 and FIG. 22 generates a load. The purpose of generating the load is to prevent movement of the medium reception tray 5 due to the own weight when it is inclined for accommodation of the recording apparatus 1 or the like or generate a sense of operation of a manual operation. Note that, at the time of power transmission, the coupling to the lock component 103 and the transmission component 104 is switched, the locking of the wheel train is canceled, and the medium reception tray 5 is driven by the motor power.

Herein, the power transmission unit 100 is configured to switch the coupling from the lock component 103 to the transmission component 104 with respect to the toothed gear 105, not only by contacting with the carriage 3 and applying an external load but also by, for example, applying an external load manually by a user, in the +X direction in which the switching lever unit 121 contacts with the carriage 3 and slides. The recording apparatus 1 of the present embodiment is thus configured. Thus, for example, when the power of the recording apparatus 1 is turned off, a user can manually switch between the power transmission state and the power non-transmission state. In addition, the number of components of the mechanism that enables a user to manually switch between the power transmission state and the power non-transmission state can be reduced.

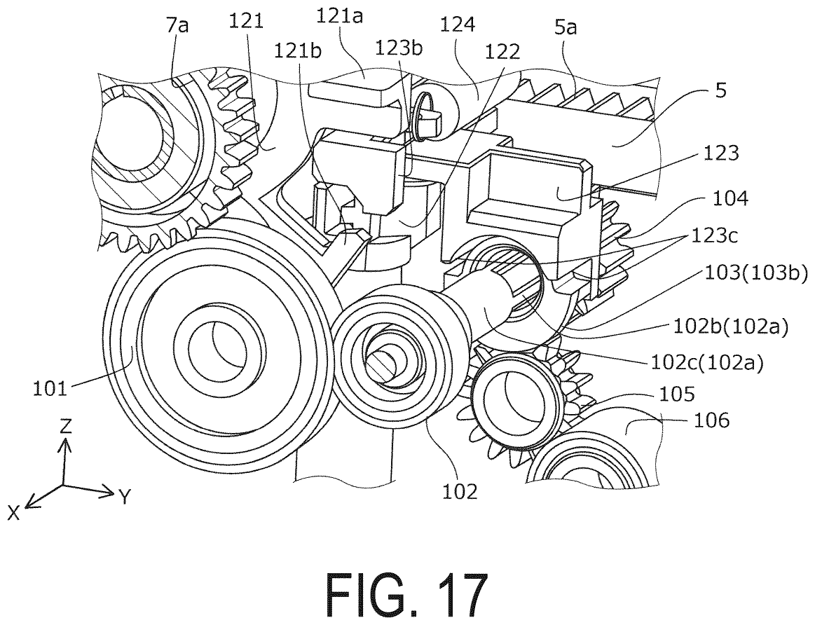

Herein, with reference to FIG. 16 to FIG. 19, the configuration of the switching mechanism for the coupling from the lock component 103 to the transmission component 104 with respect to the toothed gear 105 in the power transmission unit 100 is described. Herein, FIG. 17 to FIG. 19 illustrate the upper left state in FIG. 16, in other words, the state in which the position of the pin 123a of the holding unit 123 with respect to the cam surface 122a of the cam 122 is the first position P1 in FIG. 3. Further, for easy understanding of the shape of the rotation shaft 102a of the toothed gear 102, a compression spring 127, which is described later, is omitted in illustration in FIG. 17.

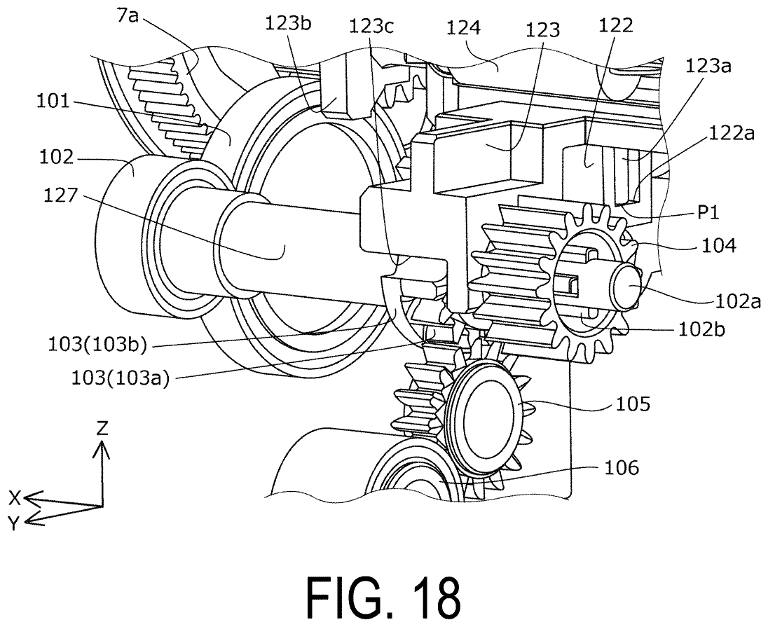

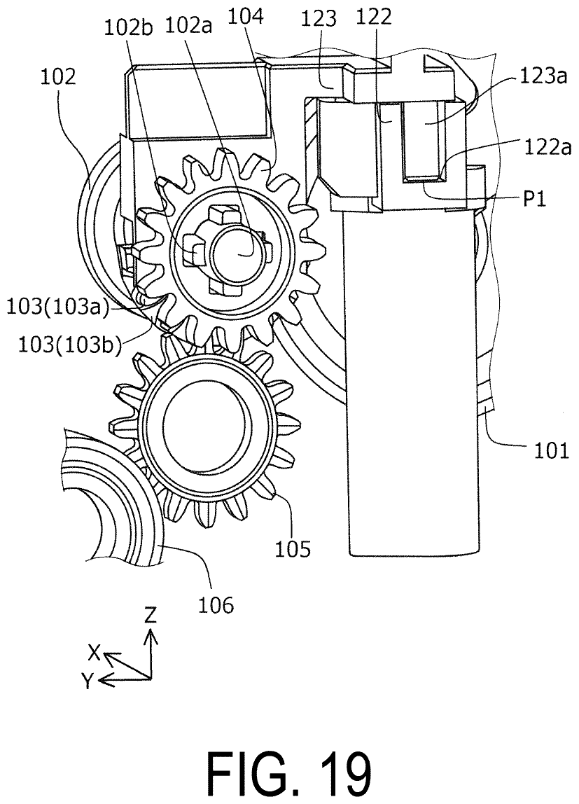

As illustrated in FIG. 18 and FIG. 19, a region on the −X direction side with respect to the center of the rotation shaft 102a of the toothed gear 102 is a cross-like shape 102b. As illustrated in FIG. 19, the transmission component 104 is provided with a hole portion having a cross-like shape that is fitted to the cross-like shape 102b of the rotation shaft 102a, and the transmission component 104 is configured to rotate at all times as the rotation shaft 102a rotates. Meanwhile, as illustrated in FIG. 16 and FIG. 17, the lock component 103 is provided with a circular hole through which the rotation shaft 102a passes. Further, in any one of the upper left state in FIG. 16 in which the lock component 103 faces the region of the cross-like shape 102b of the rotation shaft 102a, the upper right state in FIG. 16 and the lower left state in FIG. 16, or the lower left state in FIG. 16 in which the lock component 103 faces the columnar region 102c being a region other than the cross-like shape 102b of the rotation shaft 102a, even when the rotation shaft 102a rotates, the lock component 103 is configured not to rotate therewith. Note that, as illustrated in FIG. 17, a flange portion 103b, which is described later, has a substantially D-like shape. Even when the rotation shaft 102a rotates to almost cause rotation of the lock component 103, the lock component 103 is configured not to rotate therewith because an abutted portion 123c of the holding unit 123 and the flange portion 103b abut each other.

Note that, as illustrated in FIG. 18 and the like, the compression spring 127 is provided to the rotation shaft 102a between the toothed gear 102 and the lock component 103, and the lock component 103 is biased by the compression spring 127 to the −X direction side in a side away from the toothed gear 102. Further, the lock component 103 is provided with a tooth portion 103a on the −X direction side and the flange portion 103b having a substantially D-like shape on the +X direction side. The compression spring 127 described above is provided, and the lock component 103 is thus configured. Thus, even when the lock component 103 is configured so that, even when the lock component 103 temporarily comes into contact with the toothed gear 105, the teeth of the both components are engaged easily to achieve suitable positioning. In addition, the compression spring 127 described is provided. With this, when the state is shifted from the upper right state in FIG. 16 to the lower left state in FIG. 16, the transmission component 104 is configured so that, even when the transmission component 104 temporarily comes into contact with the toothed gear 105, the teeth of the both components are engaged easily.

Note that, as illustrated in FIG. 3, the power switching mechanism 120 of the power transmission unit 100 includes the cam 122 including the cam surface 122a and the holding unit 123 that holds the lock component 103 and the transmission component 104, where the pin 123a is arranged on the cam surface 122a. As described above, the pin 123a moves on the cam surface 122a between the first position P1, the second position P2, and the third position P3. With this, the power switching mechanism 120 moves between the power non-transmission state and the power transmission state. The recording apparatus 1 of the present embodiment is thus configured. As a result, the power transmission unit 100 can be configured in a small size, and the recording apparatus 1 can particularly be reduced in size.

Further, as illustrated in FIG. 3, the cam surface 122a is provided with a flat surface portion 122c on which the pin 123a is positioned when the power transmission unit 100 is in the power non-transmission state, in other words, the pin 123a is at the position other than the second position P2 on the cam surface 122a. Further, the cam surface 122a is provided with the pin holding portion 122b. The pin holding portion 122b holds the pin 123a when the power transmission unit 100 is in the power transmission state, in other words, the pin 123a is at the second position P2 on the cam surface 122a. With this configuration, when the power transmission unit 100 is in the power transmission state, position deviation of the pin 123a can be prevented.

Next, with reference to FIG. 21 and FIG. 22, the configuration of the toothed gear 110, the toothed gear 111, and the friction forming portion 112, in other words, the friction toothed gear composed of those components is described. As illustrated in FIG. 21 and FIG. 22, the toothed gear 110 includes a hook portion 110a formed on the −X direction side. Further, as illustrated in FIG. 22, the toothed gear 111 includes an abutting portion 111a formed on the +X direction side. The abutting portion 111a abuts a wall portion 110b of the toothed gear 110. When an abutting force of the abutting portion 111a with respect to the wall portion 110b is large, the toothed gear 111 is likely to rotate with the toothed gear 110. When an abutting force of the abutting portion 111a with respect to the wall portion 110b is small, the toothed gear 111 slips with respect to the toothed gear 110, and is less likely to rotate with the toothed gear 110. Herein, as illustrated in FIG. 21 and FIG. 22, the friction forming portion 112 being a compression spring is formed between the hook portion 110a and the abutting portion 111a. With this, an abutting force of the abutting portion 111a with respect to the wall portion 110b is obtained as an appropriate abutting force.

Next, a configuration of a head forming surface 3a of the carriage 3, which is a facing surface with respect to the switching lever unit 121, is described with reference to FIG. 23 and FIG. 24. Herein, FIG. 23 and FIG. 24 illustrate a state in which the carriage 3 is positioned on the furthest +X direction side within the reciprocating range A1. Specifically, the recording apparatus 1 of the present embodiment can perform so-called skew correction for suppressing skewed transport of the medium by repeating transport of the medium being transported in a transport direction and transport of the medium in a direction opposite to the transport direction. At the time of skew correction, the carriage 3 is arranged at the position illustrated in FIG. 23 and FIG. 24. Herein, at the time of screw correction, the switching lever unit 121 rotates as the transport roller 7 rotates. Thus, as illustrated in FIG. 23, the head forming surface 3a and the switching lever unit 121 contact with each other.

The carriage 3 of the present embodiment includes the recording head 4, a medium width sensor 21, a hole shape 22, and the like on the head forming surface 3a. Those are sensitive components that may undergo performance changes or the like due to contact with other components, and hence correspond to non-allowable portions that does not allow contact with the switching lever unit 121. Note that, in the carriage 3 of the present embodiment, as illustrated in FIG. 23, the distal end portion 121a of the switching lever unit 121 is arranged at a position facing the medium width sensor 21. In view of this, in the periphery of the medium width sensor 21 being a non-allowable portion, the carriage 3 of the present embodiment is provided with a guard portion 3b that guards the medium width sensor 21. Further, there is adopted a configuration in which a part of the distal end portion 121a of the switching lever unit 121, which faces the guard portion 3b, is provided with a flat facing surface. Thus, even when the distal end portion 121a contacts with the guard portion 3b, the recording apparatus 1 of the present embodiment can prevent the distal end portion 121a from contacting with the medium width sensor 21 being a non-allowable portion.

Note that the present embodiment adopts a configuration in which the distal end portion 121a of the switching lever unit 121 is arranged at the position facing the medium width sensor 21 being a non-allowable portion. Thus, the periphery of the medium width sensor 21 is provided with the guard portion 3b that guards the medium width sensor 21. However, when there is adopted a configuration in which the distal end portion 121a of the switching lever unit 121 is arranged at a position facing the recording head 4 being a non-allowable portion, the guard portion 3b may be provided in the periphery of the recording head 4. When there is provided a configuration in which the distal end portion 121a of the switching lever unit 121 is arranged at a position facing the hole shape 22 being a non-allowable portion, the guard portion 3b may be provided in the periphery of the hole shape 22.

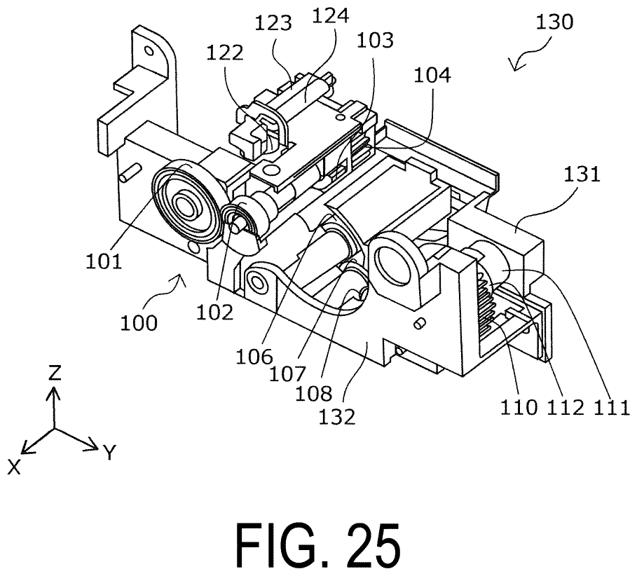

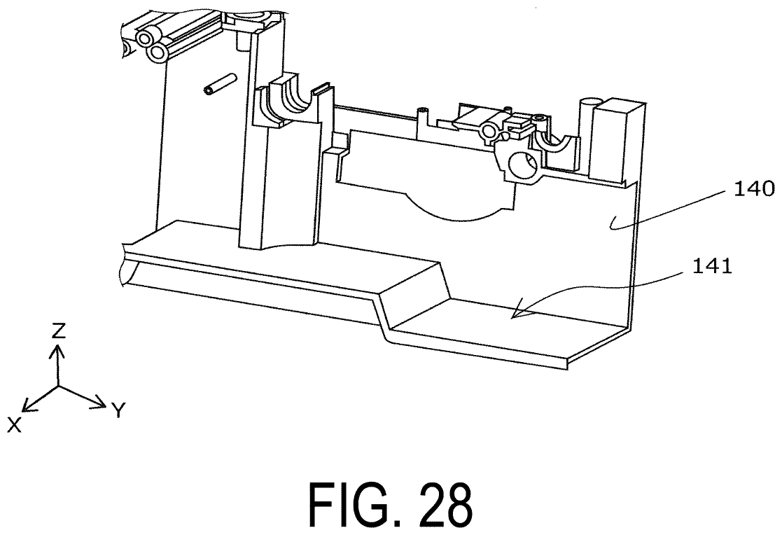

Next, a configuration attaching the power transmission unit 100 is described with reference to FIG. 25 to FIG. 28. As illustrated in FIG. 25 to FIG. 27, the power transmission unit 100 is formed as one unit 130 sandwiched between a first frame 131 including a plurality of toothed gear support portions 131a and a second frame 132 in the X axis direction. Further, the unit 130 is placed on and fixed to a placement portion 141 of a main body frame 140 to which the discharge roller 8 is attached, which is illustrated in FIG. 28.

In other words, the recording apparatus 1 of the present embodiment includes the main body frame 140 to which the discharge roller 8 is attached, and the power transmission unit 100 is provided to the unit 130 that is a separate body from the main body frame 140 and is attachable to and detachable from the main body frame 140. The recording apparatus 1 of the present embodiment is thus configured. Thus, attachment of the power transmission unit 100 into the recording apparatus 1 can be facilitated, and replacement, cleaning, or the like of the power transmission unit 100 can be facilitated.

The present disclosure is not limited to the above-described embodiments, and can be realized in various configurations without departing from the spirit of the present disclosure. Appropriate replacements or combinations may be made to the technical features in the present embodiments which correspond to the technical features in the aspects described in the SUMMARY section to solve some or all of the problems described above or to achieve some or all of the advantageous effects described above. Further, when the technical characteristics are not described as being essential in the present specification, the technical characteristics can be deleted as appropriate.

What is claimed is:

1. A recording apparatus comprising:
a recording-head attached to a carriage and configured to perform recording on a medium, the carriage being configured to reciprocate;
a transport roller configured to transport the medium;
a discharge roller configured to discharge the medium on which the recording was performed;
a medium reception tray configured to receive the medium discharged by the discharge roller, the medium reception tray being configured to be in a first state and in a second state in which the medium reception tray is displaced from the first state in a discharge direction of the medium;
a motor being a power source of the discharge roller;
a power transmission unit configured to be in a power transmission state in which power of the motor is transmitted from the motor to the medium reception tray and a power non-transmission state in which the power of the motor is not transmitted from the motor to the medium reception tray; and
a belt being stretched around a transport roller pulley provided to the transport roller and a discharge roller pulley provided to the discharge roller, wherein
the power transmission unit is positioned between an outer end portion of the transport roller pulley and an outer end portion of the discharge roller pulley in the discharge direction.

2. A recording apparatus according to claim 1, wherein
the power transmission unit is positioned on an inner side closer to a center of the recording apparatus in a reciprocating direction of the carriage than a routing range of the belt.

3. A recording apparatus according to claim 1, wherein
the power transmission unit is positioned around the motor as viewed in a direction along the reciprocating direction of the carriage.

4. A recording apparatus comprising:
a recording head attached to a carriage and configured to perform recording on a medium, the carriage being configured to reciprocate;
a transport roller configured to transport the medium;
a discharge roller configured to discharge the medium on which the recording was performed;
a medium reception tray configured to receive the medium discharged by the discharge roller, the medium reception tray being configured to be in a first state and in a second state in which the medium reception tray is displaced from the first state in a discharge direction of the medium;
a motor being a power source of the discharge roller;
a power transmission unit configured to be in a power transmission state in which power of the motor is transmitted from the motor to the medium reception tray and a power non-transmission state in which power of the motor is not transmitted from the motor to the medium reception tray; and
a switching lever unit configured to switch between the power non-transmission state and the power transmission state, wherein
the power transmission unit includes a power switching mechanism configured to switch between the power non-transmission state and the power transmission state by the switching lever unit, and
the power switching mechanism is positioned between an outer end portion of the motor and an outer end portion of the transport roller in the discharge direction.

5. A recording apparatus according to claim 4, wherein
the power switching mechanism overlaps the motor in at least one of the reciprocating direction of the carriage and an intersection direction intersecting both the discharge direction and the reciprocating direction of the carriage.

6. A recording apparatus according to claim 4, wherein
the power switching mechanism overlaps a final stage of a driving wheel train of the power transmission unit in an intersection direction intersecting both the discharge direction and the reciprocating direction of the carriage.
